(19) United States
(12) Patent Application Publication
(10) Pub. No.: US 2026/0022785 A1
(43) Pub. Date: Jan. 22, 2026

(54) PIPE CLAMP FOR ACCESSORY MOUNTING AND ACCESSORY MOUNTING DEVICE

(71) Applicant: TILTA INC., Burbank, CA (US)

(72) Inventors: Shuangqiang YANG, Shenzhen (CN); Wenping ZENG, Shenzhen (CN); Kefeng ZHOU, Shenzhen (CN)

(21) Appl. No.: 19/269,502

(22) Filed: Jul. 15, 2025

(30) Foreign Application Priority Data
Jul. 17, 2024 (CN) 2024217186346

(51) Int. Cl. F16L 3/10

(52) U.S. Cl. CPC F16L 3/1033

(57) ABSTRACT

A pipe clamp includes: a connection body featuring a first tube through hole, a second tube through hole, and an installation chamber. The installation chamber is communicatively positioned between the first and second tube through holes. A locking assembly includes a first locking member and a second locking member, both of which are movably installed within the installation chamber. The mutually opposite outer sides of the first locking member and the second locking member each have an abutment surface. These abutment surfaces are designed to abut against corresponding circular tubes when the first and the second locking members move apart. A locking actuator assembly is situated between the first locking member and the second locking member to facilitate movement of the first locking member and the second locking member. Additionally, a fixing mechanism is installed on the connection body.

### CROSS-REFERENCE TO RELATED APPLICATIONS

The present application for patent claims priority to and the benefit of pending Chinese Application No. 202421718634.6, filed on Jul. 17, 2024, which is hereby expressly incorporated by reference herein as if fully set forth below in its entirety and for all applicable purposes.

### TECHNICAL FIELD

This application pertains to the technical field of photographic equipment accessories, and more specifically to a pipe clamp and an accessory mounting device.

### INTRODUCTION

In the field of photography, as shooting environments and demands become increasingly varied, cameras often need to be mounted on photographic support equipment, such as gimbals, and paired with various accessories to meet different shooting requirements. To accommodate flexible pairing with diverse accessories, users typically install circular tubes on photographic support equipment as a mounting base, enabling accessories to be attached to the circular tubes for use. The common setup involves mounting a base on the photographic support equipment, with two parallel circular tubes installed on the base. Subsequently, various accessories can be mounted on these two circular tubes. Therefore, there is a need for a connection structure that facilitates the installation of accessories onto the circular tubes.

Existing connection structures typically feature two pipe clamps at each end, with a locking knob on each clamp to secure each circular tube individually. During use, the two pipe clamps at the ends of the connection structure are slipped onto the two circular tubes, and each clamp is tightened via its locking knob to complete the connection. However, this method of securing the circular tubes is relatively cumbersome, affecting user convenience.

### BRIEF SUMMARY

Aspects of the present disclose provide a pipe clamp and an accessory mounting device that facilitate the stable installation of accessories onto circular tubes.

According to a first aspect, in one embodiment, a pipe clamp includes:
a connection body, which has a first tube through hole, a second tube through hole, and an installation chamber; the first and second tube through holes are designed for circular tubes to pass through, and the installation chamber is communicatively positioned between the first and second tube through holes;
a locking assembly, including a first locking member and a second locking member; both the first locking member and the second locking member are movably installed within the installation chamber, and the mutually opposite outer sides of the first and second locking members each have an abutment surface; the abutment surface of the first locking member can form the first tube through hole, while the abutment surface of the second locking member can form the second tube through hole; these abutment surfaces are configured to clamp against the corresponding circular tubes when the first and second locking members move apart;
a locking actuator assembly, positioned between the first and second locking members, to drive movement of the first and second locking members; and
a fixing mechanism, installed on the connection body, for securing functional accessories.

### BRIEF DESCRIPTION OF THE DRAWINGS

FIG. 1 is a diagram illustrating a pipe clamp from a first perspective according to some aspects of the disclosure.

FIG. 2 is an exploded view of a connection body according to some aspects of the disclosure.

FIG. 3 is an internal view of a base body according to some aspects of the disclosure.

FIG. 4 is a view of the pipe clamp of FIG. 1 from a second perspective according to some aspects of the disclosure.

FIG. 5 is an exploded view of a fixing mechanism portion according to some aspects of the disclosure.

FIG. 6 is a diagram illustrating a pipe clamp with circular tubes according to some aspects of the disclosure.

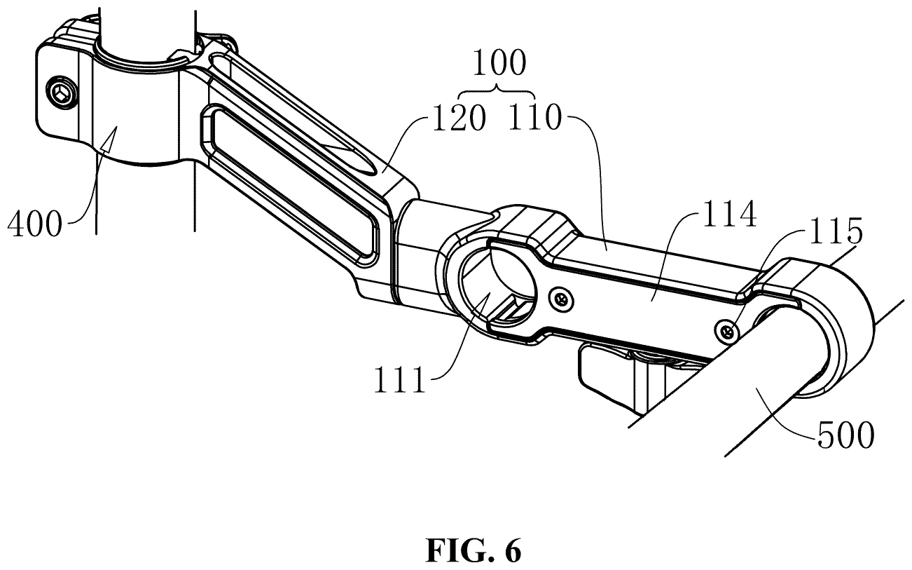

### IN THE DRAWINGS

100, connection body; 110, base body; 111, tube through hole; 111a, first tube through hole; 111b, second tube through hole; 112, installation chamber; 1121, fixing post; 1122, guide portion; 1123, guide protrusion; 113, embedding groove; 114, cover plate; 115, fixing bolt; 120, connecting body; 121, protrusion block; 122, connecting bolt;
200, locking assembly; 200a, first locking member; 200b, second locking member; 210, flat portion; 211, clearance groove; 212, driven sloping surface; 220, curved portion; 221, abutment surface; 230, second elastic member;
300, locking actuator assembly; 310, linkage member; 311, actuating sloping surface; 320, locking operator; 321, knob portion; 322, column portion; 323, first elastic member;
400, fixing mechanism; 410, clamping ring; 411, fastening cavity; 412, opening; 413, extension portion; 414, positioning protrusion; 420, locking clamp; 421, connecting rod;
422, eccentric lever; 423, spring; 430, sleeve; 431, notch;
500, circular tubes.

### DETAILED DESCRIPTION

To clarify the objectives, technical solutions, and aspects of the present disclosure clearer, the following detailed description is provided in conjunction with the accompanying drawings and exemplary embodiments. It should be understood that the specific embodiments described herein are provided for illustrative purposes only and do not limit the scope of the present disclosure. The pipe clamp described in this disclosure employs the coordinated operation of the locking assembly 200 and the locking actuator assembly 300, enabling the connection body 100 to be simultaneously mounted and firmly secured onto two circular tubes 500. This facilitates stable and rapid installation. In addition, the fixing mechanism 400 allows for the mounting and securing of various accessories, working in tandem to achieve the objective of stably installing the accessories onto the two circular tubes 500. The design facilitates the pairing of various accessories to meet diverse shooting requirements.

The term “camera” in this disclosure may refer to a standalone camera or a camera kit augmented with accessories such as lens hoods or full cages. The term “accessories” may encompass lens hoods used in photography for mounting on lenses, angle adjustment structures for lens hoods, or other accessories and auxiliaries serving specific functions.

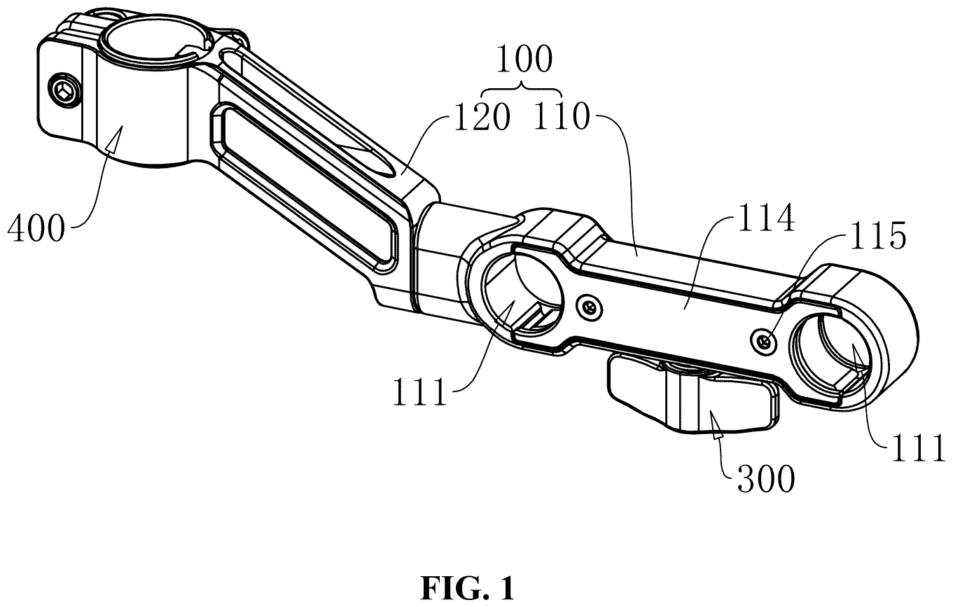

Referring to FIGS. 1-5, a pipe clamp for accessory mounting is disclosed. The pipe clamp includes a connection body 100, a locking assembly 200, a locking actuator assembly 300, a fixing mechanism 400, and other structural components as required.

Referring to FIGS. 1-3, the connection body 100 can be understood as an assembly of the foundational structural component and related parts that define the external contour of the pipe clamp. The connection body facilitates the movement, installation, and operation of the pipe clamp.

Referring to FIGS. 1-3, the connection body 100 features tube through holes 111 and an installation chamber 112. In some aspects, two tube through holes 111 are spaced apart, designated as the first tube through hole 111a and the second tube through hole 111b, respectively. Both the first tube through hole 111a and the second tube through hole 111b can be designed to allow circular tubes 500 to pass through, with the installation chamber 112 positioned between them. A fixing mechanism 400 is mounted on the connection body 100 for securing various accessories. In some aspects, the number of tube through holes 111 may vary based on installation requirements, provided it matches the number of circular tubes 500 or fulfills the purpose of securing the connection body 100 to the circular tubes 500. In some aspects, the through holes 111 can have any shape that matches the shape of the tubes 500 that part through the holes.

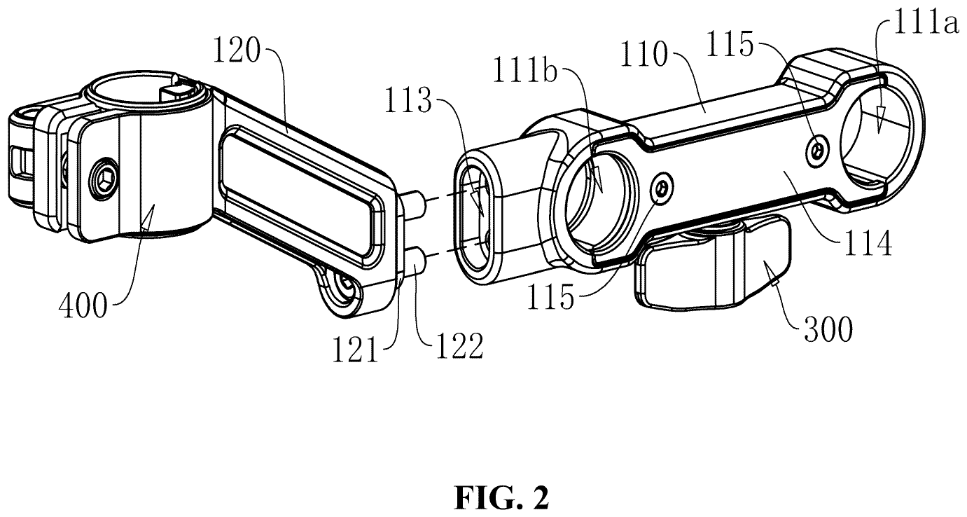

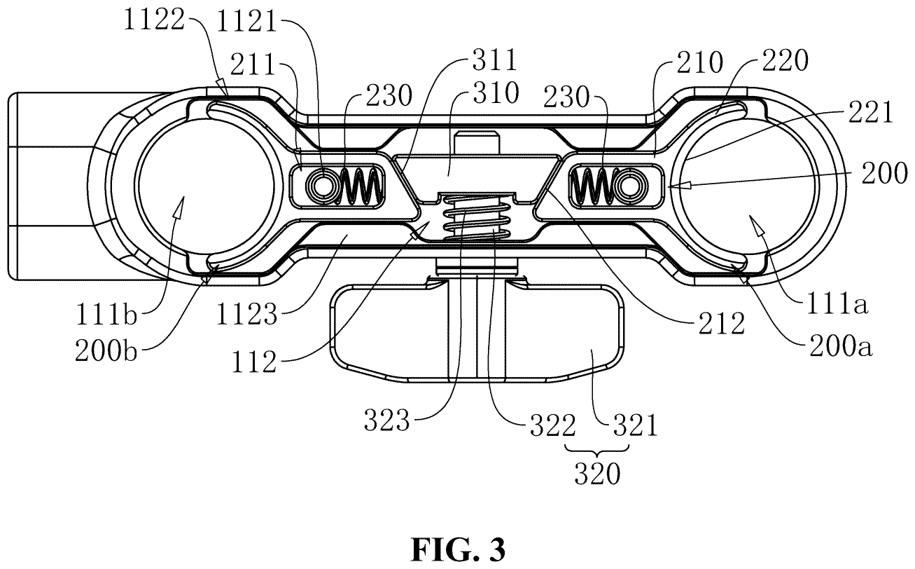

In some aspects, referring to FIGS. 2 and 3, the connection body 100 includes a base body 110 and a connecting body 120. The tube through holes 111 and the installation chamber 112 are located at the base body 110. The locking assembly 200 can be installed within the installation chamber 112, and the locking actuator assembly 300 can be correspondingly positioned at the base body 110, enabling the base body 110 to be directly mounted onto the two circular tubes 500. The connecting body 120 is attached to the base body 110, with the fixing mechanism 400 mounted on the connecting body 120 to facilitate the installation of various accessories.

In some aspects, referring to FIG. 2, the connecting body 120 is equipped with a fixing mechanism 400 at one end and a protrusion block 121 at the other end. The base body 110 features an embedding groove 113 at one end to accommodate the protrusion block 121. The connecting body 120 can be preliminarily fixed to one end of the base body 110 by engaging the protrusion block 121 within the embedding groove 113. In some examples, the protrusion block 121 can be penetrated by a connecting bolt 122, and the wall of the embedding groove 113 can be provided with a threaded hole. In response to the protrusion block 121 being inserted into the embedding groove 113, the connecting bolt 122 can be screwed into the threaded hole to further secure the connecting body 120 to the base body 110, ensuring a fixed and secured installation. In some aspects, the connecting body 120 can be integrally formed with the base body 110 or connected in other ways, provided the relative positions of the connecting body 120 and the base body 110 remain fixed during use.

In some aspects, referring to FIGS. 1 and 3, the connection body 100 is equipped with a detachable cover plate 114, which is positioned corresponding to the installation chamber 112 to facilitate the installation or adjustment of the locking assembly 200 (see FIG. 2) and other structural components within the installation chamber 112.

In some aspects, the cover plate 114 is mounted on the base body 110 and located on one side of the installation chamber 112. The side wall of the cover plate 114 adjacent to the installation chamber 112 also serves as a wall of the installation chamber 112. The cover plate 114 can be shaped approximately like a double-open-end wrench and features two spaced mounting holes, in which fixing bolts 115 are installed. On the chamber wall opposite the cover plate 114, two fixing posts 1121 (see FIG. 3) are integrally formed, corresponding to the two mounting holes of the cover plate 114. The fixing posts 1121 are spaced along the lengthwise direction of the installation chamber 112 on both sides, and each can be provided with a threaded hole for engaging with the fixing bolts 115. After installation, the cover plate 114 can be secured by the cooperation of the fixing bolts 115 and the fixing posts 1121. For example, the fixing bolts 115 can be securely screwed into the threaded holes on the fixing posts 1121.

In some aspects, the cover plate 114 can adopt different shapes and fixing methods, provided they meet design and usage requirements.

In some aspects, referring to FIG. 3, the locking assembly 200 includes two locking members, designated as the first locking member 200a and the second locking member 200b. Both are movably installed within the installation chamber 112. The sides of the first locking member 200a and the second locking member 200b facing away from each other are each equipped with an abutment surface 221. The abutment surface 221 of the first locking member 200a can form at least part of the circumference of the first tube through hole 111a, while the abutment surface 221 of the second locking member 200b can form at least part of the circumference of the second tube through hole 111b. The two abutment surfaces 221 are configured to clamp against the corresponding circular tubes 500 when the first locking member 200a and the second locking member 200b move apart from each other. During operation, after mounting the connection body 100 onto two circular tubes 500, the first locking member 200a and second locking member 200b are controlled to slide in opposite directions, causing the abutment surfaces 221 to press the respective circular tubes 500 firmly against the walls of the corresponding tube through holes 111, thereby securing the circular tubes 500 in position.

In some aspects, the first and second locking members 200a, 200b are slidably installed within the installation chamber 112, with their sliding directions aligned along the axis connecting the centers of the first and second tube through holes 111a, 111b. This arrangement enables the first locking member 200a to slide toward the first tube through hole 111a and the second locking member 200b to slide toward the second tube through hole 111b.

In some aspects, referring to FIG. 3, the ends of the first and second locking members 200a, 200b facing away from each other are each equipped with a curved portion 220. The abutment surface 221 is an arcuate surface formed on the corresponding curved portion 220. The installation chamber 112 guides the sliding motion of the curved portions 220, ensuring stable movement in cooperation with the abutment surface 221 and enhancing clamping stability.

In some aspects, referring to FIG. 3, the first locking member 200a and second locking member 200b each includes a flat portion 210 and a curved portion 220. The curved portion 220 is located at the end of the flat portion 210 adjacent to the tube through hole 111. The curvature of the curved portion 220 and the abutment surface 221 matches that of the circular tube and is semicircular in shape. The part of the installation chamber 112 that accommodates and guides the curved portion 220 also serves as a guide portion 1122. The guide portion 1122 can be formed by locally expanding the side of the tube through hole 111 adjacent to the installation chamber 112, allowing the curved portion 220 movably inserted therein. Thus, the abutment surface 221 can function as a movable wall of the tube through hole 111 on the side adjacent to the installation chamber 112, while the opposite wall serves as a fixed wall, enabling cooperated clamping of the circular tube.

In some aspects, referring to FIG. 3, the side walls of the installation chamber 112 along the sliding direction of the flat portion 210 are equipped with guide protrusions 1123. These protrusions guide the sliding motion of the flat portion 210, improving the stability of the first and second locking members 200a, 200b. In embodiments with fixing posts 1121, clearance grooves 211 may be provided on the flat portion 210 (corresponding to the fixing posts 1121) to avoid interference with the sliding motion of the flat portion 210 caused by the fixing posts 1121 while also assisting in guiding the sliding motion.

Referring to FIG. 3, the locking actuator assembly 300 is positioned between the first and second locking members 200a, 200b to drive their movement, enabling quick locking and unlocking.

In some aspects, referring to FIG. 3, the locking actuator assembly 300 includes a linkage member 310 and a locking operator 320. The linkage member 310 is movably disposed within the installation chamber 112 and positioned between the first locking member 200a and the second locking member 200b. The locking operator 320 is operatively coupled to the linkage member 310 and configured to drive movement of the linkage member 310, thereby causing the linkage member 310 to simultaneously drive the first locking member 200a and the second locking member 200b apart to clamp against the circular tubes 500. During operation, actuation of the locking operator 320 drives motion of the linkage member 310, which in turn simultaneously moves the first locking member 200a and the second locking member 200b away from each other to firmly press against the circular tubes 500.

In some aspects, the linkage member 310 can be slidably mounted in the installation chamber 112, with its sliding direction generally perpendicular to that of the first and second locking members 200a, 200b. When the linkage member 310 slides toward the first and second locking members 200a, 200b (downward in FIG. 3), it contacts and presses against the first and second locking members 200a, 200b.

In some aspects, referring to FIG. 3, the linkage member 310 can be provided with actuating sloping surfaces 311, which engage the first and second locking members 200a, 200b causing them to slide, and bringing the abutment surfaces 221 into engagement with the circular tubes 500 to achieve clamping. For example, the cross-section of the linkage member 310 may be trapezoidal, with its two oblique sides serving as the actuating sloping surfaces 311. The actuating sloping surfaces 311 contact the first and second locking members 200a, 200b, driving the first locking member 200a and the second locking member 200b to move apart from each other in response to the sliding motion of the linkage member 310 during tube locking operation. In another example, the sides of the first locking member 200a and second locking member 200b opposite their respective abutment surfaces 221 may be configured as sloping surfaces, serving as driven sloping surfaces 212 for contacting the linkage member 310. The linkage member 310 can press against these driven sloping surfaces 212 to drive the sliding motion of the first locking member 200a and second locking member 200b, thereby causing the abutment surfaces 221 to firmly clamp against the corresponding circular tubes 500. Furthermore, in some examples, the linkage member 310 with actuating sloping surfaces 311 may be cooperatively arranged with the first locking member 200a and second locking member 200b having driven sloping surfaces 212. The surface contact between the actuating sloping surfaces 311 and driven sloping surfaces 212 transmits motion more effectively, enhancing the stability of the linkage mechanism.

In some aspects, referring to FIG. 3, to enable automatic reset of the first locking member 200a and the second locking member 200b after unlocking, both the first locking member 200a and the second locking member 200b are elastically mounted in the installation chamber 112, biasing them toward each other. It should be specifically noted that “elastic mounting” refers to a connection or abutment configuration achieved using springs, elastic materials, or resilient structures. In some aspects, the elastic mounting of the first and second locking members 200a, 200b in the installation chamber 112 means that springs, clastic materials, or resilient structures are employed to bias the first and second locking members 200a, 200b toward each other, thereby enabling their self-resetting function.

In some aspects, the first locking member 200a and the second locking member 200b are each elastically mounted in the installation chamber 112 via a second elastic member 230. In some aspects, the second elastic member 230 may be a spring. Two second elastic members 230 are each disposed in a clearance groove 211, positioned between the groove wall of the clearance groove 211 and the fixing post 1121. The second elastic members 230 are arranged along the sliding direction of the first and second locking members 200a, 200b to provide an elastic force driving them away from the tube through hole 111. In some aspects, if the second elastic member 230 is positioned on the side of the fixing post 1121 closer to the linkage member 310, it is configured as a compression spring. If the second elastic member 230 is positioned on the side of the fixing post 1121 closer to the tube through hole 111, it is configured as a tension spring. Furthermore, in other examples, the first and second locking members 200a, 200b can adopt other elastic mounting methods that meet design and usage requirements.

In some aspects, the linkage member 310 may be operatively connected to the first and second locking members 200a, 200b, for example, via linkage rods, enabling the linkage member 310 to drive the first and second locking members 200a, 200b apart or together, thereby accommodating different positional requirements during installation or locking. Other configurations satisfying design and usage needs are also acceptable.

In some aspects, referring to FIG. 3, the locking operator 320 is a locking knob, including a knob portion 321 and a column portion 322. The knob portion 321 can be located outside the connection body 100. One end of the column portion 322 is connected to the knob portion 321, while the other end extends through the wall of the installation chamber 112 into its interior. The portion of the column portion 322 inside the installation chamber 112 is threadedly connected to the linkage member 310, such that rotating the knob portion 321 drives the linkage member 310 to move. During operation, rotating the locking knob causes the linkage member 310 (which is slidably constrained within the installation chamber 112) to move along the axis of the column portion 322, either toward or away from the first and second locking members 200a, 200b.

In some aspects, to ensure more stable installation of the locking actuator assembly 300 on the connection body 100 (FIG. 3), the linkage member 310 is elastically mounted in the installation chamber 112, biasing the linkage member 310 to slide away from the first and second locking members 200a, 200b. It should be specifically noted that the term “elastic mounting” refers to a connection or abutment configuration achieved using springs, elastic materials, or resilient structures. In some aspects, the elastic mounting of the linkage member 310 within the installation chamber 112 means that the linkage member 310 is biased by springs, elastic materials, or resilient structures to slide away from the first locking member 200a and second locking member 200b, thereby maintaining the knob portion 321 in constant abutment with the outer wall of the connection body 100. In some examples, the knob portion 321 may be replaced with an eccentric-head-type wrench. When the wrench being engaged, its eccentric head acts to pull the linkage member 310 in the direction that presses against the first locking member 200a and second locking member 200b.

In some aspects, a first elastic member 323, such as a compression spring, can be sleeved over the column portion 322 between the linkage member 310 and the chamber wall of the installation chamber 112. The first elastic member 323 applies an elastic force to the linkage member 310, ensuring that the knob portion 321 remains pressed against the outer wall of the connection body 100—particularly in the unlocked state where the linkage member 310 is not pressing against the locking members 200a, 200b. In other examples, multiple first elastic members 323 (e.g., two, three, or four) may be used, with two positioned on opposite sides of the column portion 322. The arrangement of the first elastic member 323 serves to address the issue of excessive looseness and poor stability of the locking actuator assembly 300 in the unlocked state, thereby enhancing the overall stability of the locking actuator assembly 300. The first elastic member 323 may be implemented as a spring.

In some aspects, the column portion 322 can be threadedly connected to the chamber wall of the installation chamber 112 while being rotatably connected to the linkage member 310, ensuring the stability of the locking actuator assembly 300. Alternatively, the locking operator 320 may employ other structures such as an eccentric locking lever, provided they meet design and usage requirements.

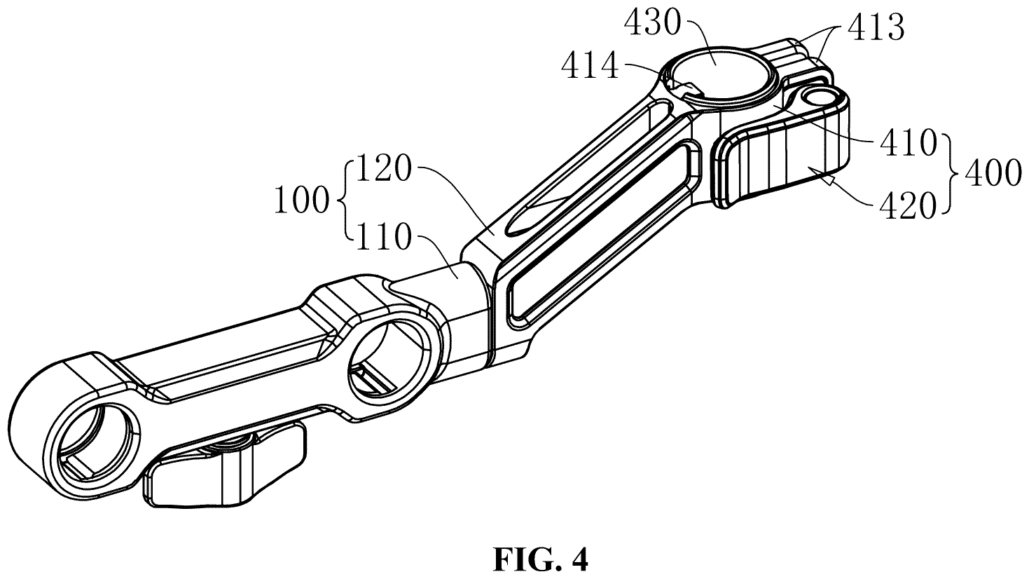

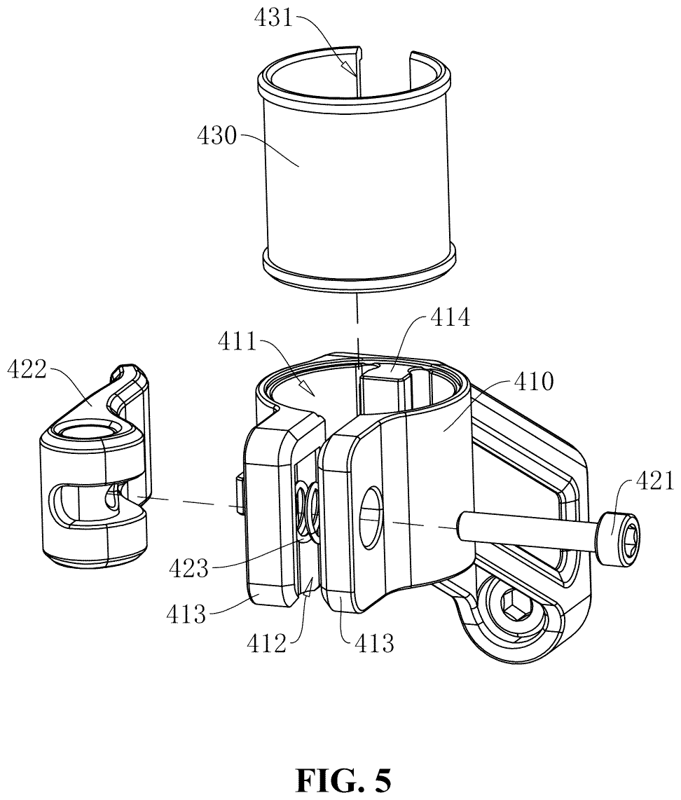

Referring to FIGS. 4 and 5, the fixing mechanism 400 includes a clamping ring 410 fixed to the connection body 100. The clamping ring 410 features a fastening cavity 411 for securing various accessories. During installation, the mounting portion of an accessory is secured in the fastening cavity 411.

In some aspects, referring to FIGS. 4-5, the clamping ring 410 is fixed to the connection body 100 on one side and features an opening 412 on the opposite side. Both ends of the opening 412 extend outward to form extension portions 413 away from the fastening cavity 411. The fixing mechanism 400 further includes a locking clamp 420 connecting the two extension portions 413, capable of drawing them together consistently to narrow the opening 412, thereby clamping the accessory's mounting portion in the fastening cavity 411.

In some aspects, referring to FIGS. 4-5, the locking clamp 420 includes a connecting rod 421 and an eccentric lever 422. The connecting rod 421 passes through the extension portions 413, with one end engages one extension portion 413, while the other end is provided with a threaded segment. The eccentric lever 422 has a pivot shaft that is perpendicular to and threadedly engages the threaded segment. When the eccentric lever 422 is flipped to the locked position, the extension portions 413 are pressed together, narrowing the opening 412 to secure the mounting portion of the accessory in the fastening cavity 411. In some examples, a spring 423 (compression spring) may be positioned between the extension portions 413, with the connecting rod 421 passing through the spring. The spring 423 provides an elastic force to automatically reset the extension portions 413 when the eccentric lever 422 is unlocked, facilitating accessory removal.

In some aspects, referring to FIGS. 4-5, the clamping ring 410 includes a positioning protrusion 414, which is configured to engage with a positioning groove of the accessory in a mating connection, thereby restricting rotational movement of the functional accessory and preventing deflection.

In some aspects, referring to FIGS. 4-5, a sleeve 430 may be fitted inside the clamping ring 410, optionally featuring a notch 431 to accommodate the positioning protrusion 414. The sleeve 430 is provided to enhance the fastening effect on the mounting portion of the accessory. In some further aspects, the sleeve 430 can be made of nylon material, which offers excellent wear resistance and further improves the clamping and securing performance.

In some aspects an accessory mounting device includes two parallel circular tubes 500 and the aforementioned pipe clamp installed on both circular tubes 500, wherein the pipe clamp incorporates any of the pipe clamp embodiments described above. Users may mount the circular tubes 500 described herein to a mounting base of a support structure. For example, the support structure may be a tripod, with the mounting base installed on the tripod's gimbal.

As used in the claims, the indefinite articles “a” and “an” should be understood to mean “one or more” unless explicitly stated otherwise or unless the context clearly dictates a singular interpretation. The use of these articles does not limit the claimed invention to a single instance of the referenced element but rather encompasses multiple instances where applicable

What is claimed is:

1. A pipe clamp, comprising:
a connection body, wherein the connection body is provided with a first tube through hole, a second tube through hole, and an installation chamber, wherein the first tube through hole and the second tube through hole are configured to receive respective tubes passing therethrough, and wherein the installation chamber is communicatively provided between the first tube through hole and the second tube through hole;
a locking assembly comprising a first locking member and a second locking member, wherein the first locking member and the second locking member are both movably provided within the installation chamber, wherein sides of the first locking member and the second locking member facing away from each other are respectively provided an abutment surface, wherein the abutment surfaces are configured to abut against the respective tubes in response to the first locking member and the second locking member moving away from each other; and
a locking actuator assembly disposed between the first locking member and the second locking member, wherein the locking actuator assembly is configured to drive the first locking member and the second locking member; and
a fixing mechanism provided on the connection body, wherein the fixing mechanism is configured to fix an accessory to the pipe clamp.

2. The pipe clamp according to claim 1,
wherein the locking actuator assembly comprises:
a linkage member movably provided between the first locking member and the second locking member; and
a locking operator movably connected to the linkage member; and
wherein the locking operator is configured to move the linkage member, causing the first locking member and the second locking member to move away from each other to abut against the tubes.

3. The pipe clamp according to claim 2, wherein the locking actuator assembly further comprises a first elastic member; and
wherein the first elastic member is provided between the linkage member and a cavity wall of the installation chamber to elastically retain the linkage member within the installation chamber.

4. The pipe clamp according to claim 3, wherein the locking operator comprises a locking knob including a knob portion and a column portion;
wherein the knob portion is provided outside the connection body;
wherein a first end of the column portion is connected to the knob portion, and a second end of the column portion extends through a cavity wall of the installation chamber into the installation chamber; and
wherein a part of the column portion provided within the installation chamber is threadedly connected to the linkage member, enabling rotation of the knob portion to drive the linkage member

5. The pipe clamp according to claim 4, wherein the first elastic member is sleeved on the column portion.

6. The pipe clamp according to claim 4, wherein the first elastic member comprises a plurality of elastic members movably provided at respective sides of the column portion.

7. The pipe clamp according to claim 2, wherein the linkage member is configured with a first actuating sloping surface and a second actuating sloping surface, respectively corresponding to the first locking member and the second locking member;
wherein the linkage member is configured to push the first locking member and the second locking member to slide via the respective actuating sloping surfaces, causing the abutment surfaces of the first locking member and the second locking member to abut against the respective tubes; and
wherein sides of the first locking member and the second locking member away from the abutment surfaces are respectively provided a driven sloping surface; and
wherein the linkage member is configured to press against the driven sloping surfaces to slide the first locking member and the second locking member, enabling the abutment surfaces to abut against the tubes.

8. The pipe clamp according to claim 2, wherein the linkage member is configured with a first actuating sloping surface and a second actuating sloping surface, respectively corresponding to the first locking member and the second locking member;
wherein the linkage member is configured to push the first locking member and the second locking member to slide via the respective actuating sloping surfaces, enabling the abutment surfaces to abut against the tubes.

9. The pipe clamp according to claim 2, wherein sides of the first locking member and the second locking member away from the abutment surface are respectively provided a driven sloping surface; and
wherein the linkage member is configured to press against the driven sloping surfaces to slide the first locking member and the second locking member, enabling the abutment surfaces to abut against the tubes.

10. The pipe clamp according to claim 1, wherein ends of the first locking member and the second locking member facing away from each other are respectively provided a curved portion;
wherein the abutment surface comprises an arcuate surface provided on the corresponding curved portion; and
wherein the installation chamber is configured to guide a sliding motion of the curved portion.

11. The pipe clamp according to claim 1, wherein the first locking member and the second locking member are both elastically provided within the installation chamber, enabling the first locking member and the second locking member to move closer to each other.

12. The pipe clamp according to claim 1, wherein the fixing mechanism comprises a clamping ring fixed to the connection body; and
clamp the accessory.

13. The pipe clamp according to claim 12, wherein a side of the clamping ring away from the connection body is provided with an opening;
wherein two ends of the clamping ring at the opening each extend away from the fastening cavity to form respective extension portions;
wherein the fixing mechanism further comprises a locking clamp; and
wherein the locking clamp connects the two extension portions and is configured to drive the two extension portions to move closer and hold position, enabling the opening to contract.

14. The pipe clamp according to claim 11, further comprising a positioning protrusion disposed in the clamping ring, wherein the positioning protrusion is configured for cooperation with a positioning groove of the accessory.

15. The pipe clamp according to claim 11, further comprising a sleeve clamped in the clamping ring.

16. An accessory mounting device, comprising two circular tubes arranged in parallel and a pipe clamp installed on the two circular tubes; and
wherein the pipe clamp is the pipe clamp according to claim 1.
